(19) United States
(12) Patent Application Publication
(10) Pub. No.: US 2010/0264656 A1
(43) Pub. Date: Oct. 21, 2010

(54) ORBITING POWER PLANT

(76) Inventor: Kerry A. Flood, Santa Maria, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/425,279

(22) Filed: Apr. 16, 2009

(51) Int. Cl. H02K 7/18; F03G 6/06

(52) U.S. Cl. 290/52; 60/641.15

(57) ABSTRACT

A self-contained orbiting power plant receives and directs solar radiation as an energy source to heat the working fluid of a Rankine-type engine used to power an electrical energy generator and create a pseudo-gravity environment in which the buoyant force exists. Through the use of reflectors and alignment of the power plant with the solar radiation source, the low temperature of outer space is used as a heat sink to condense steam back into the liquid phase. The working fluid (e.g. water) is pressurized and heated to the elevated vaporization point and the expansion of the superheated steam is captured through rotation of the power plant in the microgravity environment. The steam is used to rotate an electrical generator turbine and a counter-rotation hull turbine. The steam is cooled by conductive heat transfer to a cooling fluid (e.g. liquid ammonia) which radiates excess heat to outer space, and to return the working fluid to the liquid phase for recirculation. The produced electrical current is transformed and transmitted as microwave energy. The power generated may be transformed to specific transmittable wavelengths to decompose greenhouse gases in the atmosphere during transmission.

### BACKGROUND OF THE INVENTION

The invention is generally related to power generation and, more particularly, to a power plant orbiting above the earth adapted for generating electrical power from solar energy.

Dependence on foreign oil poses a threat to the economy of any country of the world, creating a need for the development of alternatives. Additionally, the use of fossil fuels is a proven cause of imbalance in the earth's atmospheric composition. The large-scale use of fossil fuels has produced conditions whereby global climate change poses an increasingly grave threat to civilization. If radical climate change is not prevented, it could trigger an ecological collapse that would undermine the capacity of the earth to support known life forms. In order to avoid the worst consequences of global climate change, the 2007 Intergovernmental Panel on Climate Change (IPCC) report suggested a ten-year window of opportunity to reduce global greenhouse gas emissions to pre-1990 levels. Greenhouse gas levels have been elevated to artificially high levels. Consequences of climate change are predicted to increase in the future and would do so even if all human emissions of greenhouse gases are reduced to zero immediately. In light of the alarming fact that the impact scenarios modeled in the IPCC report have already been shown by recent data to be conservative, it is thought that development of alternative technology within the necessary time frame would best be accomplished via international cooperative effort.

Methods for reducing the levels of presently existing greenhouse gases residing in the earth's atmosphere have been studied for many years. Such methods have proven to be either impractical or have not been suitably developed for widespread use. At this time, no viable solutions have been implemented and the rate of the earth's natural processes which normally balance the concentration of such gases has been exceeded by man-made emissions.

Sources of electrical power generation for the U.S. power grid must meet certain specific criteria to be viable. The two functioning criteria are: (1) Cost—Energy production is privatized and cost is a primary consideration for determining source viability. Since energy producers have historically been subsidized by public funding, cost is not necessarily a limiting factor. The construction of massive hydroelectric sources such as the Hoover Dam is an example of a power source that is not cost effective. As non-renewable sources are depleted, and power sources requiring capital investment without immediate return are needed, the burden of cost is expected to be further shifted to the public sector; and (2) Reliability—A continuous quantity of power is necessary to meet the continuous demand of modern civilization. This quantity increases as population increases. If a power plant or source is taken off the grid, alternative sources are immediately drawn upon when available. Even our most reliable sources are now threatened by the increasing frequency and intensity of storms caused by the changing climate.

Coal is presently the major source of fuel for electrical power plants in the U.S. and numerous other developed nations. Although accessible coal deposits could last for centuries, it remains a non-renewable fossil fuel and cannot be relied upon indefinitely. Coal is burned in order to heat water and produce steam to drive generators. It is one of the most significant contributors of excess carbon dioxide (a greenhouse gas) due to its being a fossil fuel.

Another limiting factor to the viability of coal power plants is the need for water to cool steam used to drive generators. In some areas, water availability has become a problem as population increases. As climate change progresses, this problem is expected to worsen. In the southwestern U.S., water for municipal and agricultural uses is already in short supply. Southern California is largely supplied by water from the Colorado River Basin. Coal is mined and power produced in sub-basins of the Colorado River. As limits are reached on the amount of water available, conflicts in use arise. The municipal water supply for the City of Los Angeles is now augmented by water once used for agriculture, obtainable only by paying farmers not to grow food. Any water made available for power plants becomes a trade-off with other uses, including drinking water and agriculture. Since the changes in climate include drying of the southwestern U.S. and less water in the Colorado River Basin, it is readily seen that such conflicts of water use can only lead to increasing hardship. The conflicts between the supply and demand for food, water, and electricity to maintain our lifestyles have led to destructive exploitation of natural resources in foreign countries. This includes reduction of rain forests, which further exacerbates greenhouse gas concentration.

Nuclear power plants can provide reliable power; however, cost is a nearly incalculable factor, since the risk and potential consequences vastly outweigh the value of any possible economic return. Aside from potentially significant environmental hazards, widespread use of nuclear fuel for power generation would necessarily proliferate nuclear technology, which is an unwise course considering current political conditions. Nuclear power technology has been generally rejected by the public as unviable from a risk/benefit standpoint. Development of sufficient nuclear power generation capacity to replace existing coal plants would be logistically problematic since large quantities of water are required to keep nuclear cores cool. The Seabrook plant constructed off the coast of New Hampshire was closed within a few years of operation due to the negative effect caused by the use of ocean water for cooling. The water temperatures in the Grand Banks region of the Atlantic increased so as to alter the ecology of the ocean. Nuclear power is an undesirable alternative to fossil fuels.

Wind power is considered viable only as a supplemental power source within the U.S. since wind vectors change due to influences beyond our control. Although existing wind power technology provides energy without the addition of fuel, it is considered a reasonable supplemental energy source but not a viable replacement alternative.

Current solar power technology is limited to producing energy only during daytime and cloud cover lowers efficiency. Large areas of open space are needed to install panels that produce relatively small quantities of electricity. Although existing solar power technology provides energy without the addition of fuel, it is considered a reasonable supplemental energy source but not a viable replacement alternative.

Some alternative forms of power generation in use and under development such as geothermal and tidal current/wave generators are limited by geography. Often other uses for and ecological functions of suitable areas must be disturbed or interfered with to install facilities for power generation.

The expected impacts of global climate change include widespread drought in some areas and increased runoff and flooding in others, devastation from rising ocean levels, increased frequency and intensity of hurricanes and tornados, potential tsunamis and earthquakes, and possible increases in volcanic activity. All of these factors threaten current global power supply and distribution. Transportation of fuels for power plants is threatened. Rail lines used to transport coal are at risk due to increased flood stages resulting from unstable climate and altered hydrologic cycle. The present power grid cannot be maintained with reasonable reliability under such increasing risks.

The idea of using the sun to heat gas/liquid in outer space to generate electricity and using the cold of shielded space to cool the same gas/liquid was conceived at least as early as the early 1980s. While some people have conceived equipment that may superficially appear to be able to accomplish such a result, that equipment has generally not been adequately designed to successfully operate in an outer space environment where physical processes operate differently than they do in a surface gravity environment.

Problems arise as a result of the microgravity environment. One problem is the absence of sufficient buoyant force to separate gas from liquid when boiling. A second problem is the inability to transfer heat by convection, which is a direct consequence of buoyancy. A third problem is described by Newton's Third Law of mechanics as “every action has an equal and opposite reaction.” All three problems must be resolved for equipment to function successfully in an outer space environment. A fourth problem is the low density of matter in outer space and consequent absence of heat transfer by conduction. A fifth problem associated with the low density of matter is the intensity of direct solar radiation and the heating effect it has on space vehicles.

Problems 1 and 2—Boiling in Space. Experiments performed by NASA on boiling liquids reveal that in space, gas does not separate from liquid the way it does when boiling on the earth's surface. On earth, steam rises in a direction “vertically” through the center of gravity of the displaced liquid. Due to gravity, fluids and gases at rest stratify according to density. Essentially, the more dense liquid or gas occupies space closer to the earth's center of mass, forcing less dense liquid or gas to be displaced farther from the earth's center of mass. Other forces at work during boiling such as vaporization pressure and adhesion are normally insufficient to overcome buoyancy in the earth's gravitational field near the surface. Heat convection is directly related to and dependant on the buoyant force. In space where the gravitational field is weak, the buoyant force is inapplicable. This also means heat convection does not appreciably occur. Other forces are dominant, and gas bubbles adhere to the sides of a boiling container instead of moving uniformly in a specific direction. This creates additional problems such as lack of uniform heat conduction from the boiler to the liquid, so the temperature of the boiler walls is non-uniform. There is also an obvious lack of liquid/gas separation and predictable gas flow which is necessary if the use of steam is an objective.

Problem 3—The Reaction to an Applied Force. The steam turbines used to produce electricity on earth rotate at high speeds, typically three-thousand revolutions per minute, sometimes higher. Generators would not stay in place if they were not solidly anchored to the earth, a phenomenon we take for granted on the surface. Generators exert force upon the earth, but the earth is so massive that the effect is not noticeable.

The magnets of an electromagnetic induction generator operating in space would produce a magnetic field which would act on the coils of the generator even though the coils would not be physically attached. The same force would act on whatever the coils are mounted to, eventually rotating the whole at the same speed as the rotor thereby terminating the generation of electrical power. Note that regardless of the type of engine used to operate a generator, the same problem exists. Forces applied must be counter-acted, and the more directions forces act, the more complicated counter-acting them becomes. Therefore, a simple rotating turbine is preferred over a Sterling engine or similar piston engine. Also, it is not thought feasible to attempt to build a satellite massive enough to negate forces induced by motion so other methods must be devised to control those forces.

Problem 4—No Heat Conduction in Empty Space. The standard method of condensing steam in the Rankine cycle power plants on earth relies on heat transfer by conduction, typically performed with large quantities of water. Although outer space is not entirely empty, the molecular density of the atmosphere at orbital distances from earth is so low that heat conduction into space is ineffective, therefore other heat transfer processes must be relied upon.

Problem 5—Intensity of Undiffused Solar Radiation. As mentioned, materials exposed to undiffused solar radiation can reach extremely high temperatures. Depending on the material and frequencies absorbed, molecular structures can be altered; i.e. metals can warp and melt. Radiation shielding and insulation were significant engineering concerns for early manned spacecraft.

Hence, those skilled in the art have identified a need for a means to eliminate demand for fossil fuels and thereby nullify the threat of global conflict over such non-renewable fuels. A need has also been recognized for a way to replace fossil fuels with other power sources. A further need is to reduce greenhouse gas emissions to natural background levels, preferably, to pre-industrial age levels. Further, a need has been recognized to transform abundant sunlight from a position above earth's atmosphere into electrical power and direct that electrical power to the earth's surface. In order to do so, a need has been recognized for designing a spacecraft for functionality in efficiently converting sunlight to electrical energy. The invention fulfills these needs and others.

### SUMMARY OF THE INVENTION

Briefly and in general terms, the present invention is directed to an orbiting power plant that uses direct solar radiation as a source from which electrical energy is generated. Radiation is collected and focused so as to cause a working fluid to heat sufficiently to change to a gaseous phase. The resultant gas is separated from the liquid medium and is superheated. The pressurized gas is then directed into a suitable generator in which kinetic energy is converted into electrical energy. The heated gas is cooled and restored to the liquid phase and circulated back into the cycle in a continuous loop.

In more detailed aspects, there is provided an orbiting power plant for generating electrical energy in a microgravity environment from solar radiation, the orbiting power plant comprising a hull, an electrical generator disposed in the hull and having an input and an output, the generator comprising a moving electrical device at the input, the generator configured to produce electrical energy at the output in response to the application of energy to the moving electrical device at its input, wherein the moving electrical device has a first movement direction, a radiation collection system configured to receive solar radiation energy and direct the solar radiation energy to a predetermined position on the hull, a working-fluid engine comprising a first stage disposed at the predetermined position on the hull at which a lower-energy-state working fluid absorbs the directed solar radiation energy to result in a higher energy state of the working fluid, a second stage at which the higher energy state working fluid is applied to the moving electrical device at the input of the generator at which at least some of the energy of the working fluid is transferred to the moving electrical device whereby electrical energy is generated, and a third stage at which the higher-energy-state working fluid releases energy to result in a lower energy state, and a pseudo gravity generation system to which the higher-energy-state working fluid is applied to transfer energy to said pseudo gravity system, the pseudo gravity generation system configured to generate a pseudo gravity environment in the orbiting power plant in response to the energy from the working fluid thereby producing a buoyant force in the hull to enable operation of the working-fluid engine and providing force that opposes tendency of the hull to move with the moving electrical device of the generator.

In more detailed aspects, the moving electrical device comprises a rotor with attached generator turbine to which energy of the working fluid is applied to cause rotation of the rotor in the first movement direction to generate electrical energy. The pseudo gravity system comprises a hull turbine to which the working fluid is applied to impart rotational force to the hull opposite to the rotation direction of the rotor to oppose tendency of the hull to move with the rotor. The generator turbine and the hull turbine are co-located with the generator turbine disposed within the hull turbine, with both turbines having a plurality of turbine blades with the blades of the generator turbine having a different orientation than the blades of the hull turbine so that the hull turbine and the generator turbine rotate in different directions when exposed to the working fluid, and further comprising a manifold feeding the working fluid to both the generator and hull turbines.

In yet other detailed aspects in accordance with the invention, the pseudo gravity system comprises a turbine to which the working fluid is applied to cause the hull to rotate and create centrifugal force and the working-fluid engine comprising a liquid separator at the predetermined position of the solar radiation configured to permit the working fluid in the higher-energy state to pass to the turbines but to restrict the working fluid in a liquid state from passing.

Additional more detailed aspects include the working fluid engine comprising a cooling system configured to cool the working fluid to the lower-energy state after it has applied energy to the generator and hull, the hull comprises a shield located between the source of solar radiation and the cooling system to shield the cooling system from direct solar radiation whereby the temperature of the environment of the cooling system is less than the temperature of the environment of the solar radiation collection system.

Yet further aspects comprise an attitude control system configured to automatically align the orbiting power plant with a solar source from which solar radiation is received whereby the shield is placed in position to shield the cooling system from the solar radiation being received. The attitude control system comprises a plurality of masses and a mass position control system with which the positions of the masses are adjustable whereby the attitude of the orbiting power plant may be adjusted. The radiation collection system comprising a plurality of reflectors configured and located to reflect solar radiation to the predetermined position on the hull at which the first stage of the working fluid engine is located.

More aspects include a wireless transformer which is configured to wirelessly transmit the energy produced by the electrical generator to a remote location. The transformer is further configured to selectively control at least one characteristic of the electrical energy transmitted to the remote location such that the transmitted energy will interact with a material disposed in a medium located between the transformer and the remote location to alter a characteristic of the material.

Yet even further aspects comprise a refrigerant cooling system disposed about the electrical generator to provide cooling to the generator. The refrigerant cooling system is also disposed to provide cooling to the working fluid.

The features and advantages of the invention will be more readily understood from the following detailed description that should be read in conjunction with the accompanying drawings.

### BRIEF DESCRIPTION OF THE DRAWINGS

FIG. 1 presents a perspective front angled view of an orbiting power plant in accordance with aspects of the present invention showing various external components that include reflectors of a solar energy control system, a fuselage that includes an electrical power generator, symmetrical cooling rings, a rotational balancing system, and a reflector for a wireless energy transfer system;

FIG. 2 is a perspective front angled view of a second embodiment of an orbiting power plant in accordance with aspects of the present invention in which the solar energy control system and boiler are varied somewhat from the orbiting power plant of FIG. 1, with other features remaining the same;

FIG. 3 is a side view of the orbiting power plant of FIG. 2 showing more clearly the fuselage disposed within the cooling rings, and showing the transformer module that houses the wireless energy transformer, an antenna controller, and a processor configured to control the rotational balancing system of the power plant to maintain alignment with the solar power source, as well as perform many other maintenance and operational functions;

FIG. 4 is a partially exploded view of parts of the solar energy control system of FIG. 1 used to direct solar energy to a Rankine-type engine showing the reflectors, the filter and lens array, the gas separator with membrane, the boiler chamber, working fluid feed lines, and the line feeding the steam into a turbine;

FIG. 5 is a diagrammatical view of the operation of the solar energy control system showing the operation of the various reflectors in directing solar radiation where needed within the orbiting power plant of FIG. 1 for providing heat to create steam to effectively drive an electrical energy generator and to create a pseudo-gravity environment within the hull of the power plant;

FIG. 6 is a diagram similar to FIG. 4 but with a partial cross-sectional view showing a hull turbine and an expansion chamber forming part of the Rankine-type engine, the expansion chamber having a steam outlet port, the diagram having the water feed lines removed for clarity;

FIG. 7 shows the fuselage hull seen in FIGS. 1, 2, and 3 that houses the electrical energy generator, turbines, and cooling jackets as well as showing the outlet ports for the working fluid in gas form that has passed through the hull turbine;

FIG. 8 shows part of the electrical energy generator including rotating magnets forming a part of the rotor, seals at both ends, and a pair of turbines, the inner of which is used to drive the electrical energy generator and the outer of which is used to provide counter-rotation, or counter force to the fuselage hull;

FIG. 9 is an exploded view of the turbines of FIG. 8 showing the inner turbine for causing rotation of the generator rotor (as shown in FIG. 8), having an expansion chamber directly behind the generator turbine, and the outer fuselage hull turbine for providing rotational force to the fuselage hull and to coils of the generator counter to the rotational direction of the generator rotor, the outer turbine having the same expansion chamber directly behind it as the generator turbine (the same expansion chamber is shown twice);

FIG. 10a is a side view of the rotor turbine connected with the shaft of the rotor and showing the coils surrounding the rotor, the figure also showing portions of the manifold at the input end of the rotor turbine and showing seals at either end of the coils;

FIG. 10b is similar to FIG. 10a except that the coils have been partially removed and the front seal has been removed so that the magnets on the rotor can be seen;

FIG. 11 presents a perspective frontal-side view of symmetrical steam cooling rings used to change the state of the working fluid from a gas to a liquid, showing both the evenly-spaced steam tubes for contacting the fuselage and the evenly-spaced outlet water tubes for providing water to a recirculation pump to be used in the Rankine-type engine. Outer refrigerant cooling rings have been removed for clarity;

FIG. 12 is an end-on or axial view of the cooling system of FIG. 11 showing the cooling system, less the water output tubes, in particular showing the water cooling system surrounded by a second cooling or refrigerant system used both to cool the water and to provide cooling to the electrical energy generator, the radial tubes being used to connect with the steam outlet holes in the fuselage shown in FIG. 7, the tubes in one embodiment having a second tube within each for conducting the refrigerant, such as ammonia, from a cooling jacket located about the electrical generator;

FIG. 13 is a view of the cooling rings shifted more to the side than that of FIG. 11 to more clearly show the water outlet tubes disposed at an angle to the end ring for connecting with a recirculation water pump. The fin-shaped outer refrigerant cooling rings have not been removed in this figure;

FIG. 14 is a schematic cross-sectional view of the fuselage showing the various elements and jackets, including in the center the electrical energy generator rotor, the next outer layer consisting of the stator of the generator, the next layer comprising a cooling jacket over the stator for the circulation of a refrigerant or coolant to remove heat produced by the generator, and the final outer layer comprising a cooling jacket for removing heat from the steam that was used to rotate turbines in the fuselage, showing one example of the connection of tubes, one inside the other, to separate jackets;

FIG. 15 provides a schematic block diagram of the operation of the Rankine-type engine used in one embodiment of the orbiting power plant in which the working fluid is raised in temperature to a gaseous state, the gas separated from liquid, the gas channeled to the generator turbine to turn the generator in one direction and simultaneously channeled to the hull turbine to provide counter rotational force to the hull, the gas condensed and cooled to the liquid phase, provided to a reservoir, and pumped back to the boiler;

FIG. 16 is a schematic diagram of the flow of power through the orbiting power plant of FIG. 1 showing solar radiation being received at the left, the various processing steps of generating electricity from that received solar radiation, transforming the generated electrical energy, and the use of wide and directional microwave antennae at the bottom of the drawing to wirelessly transmit that power to the earth;

FIG. 17 is a drawing showing the orbiting power plant of FIG. 1 in alignment with a solar energy source so that the solar radiation reflectors operate efficiently as designed;

FIG. 18 shows the orbiting power plant of FIG. 1 misaligned with the solar energy source such that the sun's radiation will strike along the body of the orbiting power plant and yield the solar reflectors only partially effective; and

FIG. 19 is a diagrammatic view of the operation of an orbiting power plant in accordance with FIG. 1 which is in a fixed, non-geosynchronous orbit over the earth, and a plurality of geosynchronous relay satellites placed over selected positions of the earth, the orbiting power plant wirelessly transmitting the electrical power it generates to various grids in different locations of the earth through the relay satellites as they come into the transmission beam of the orbiting power plant.

### DETAILED DESCRIPTION OF THE PREFERRED EMBODIMENTS

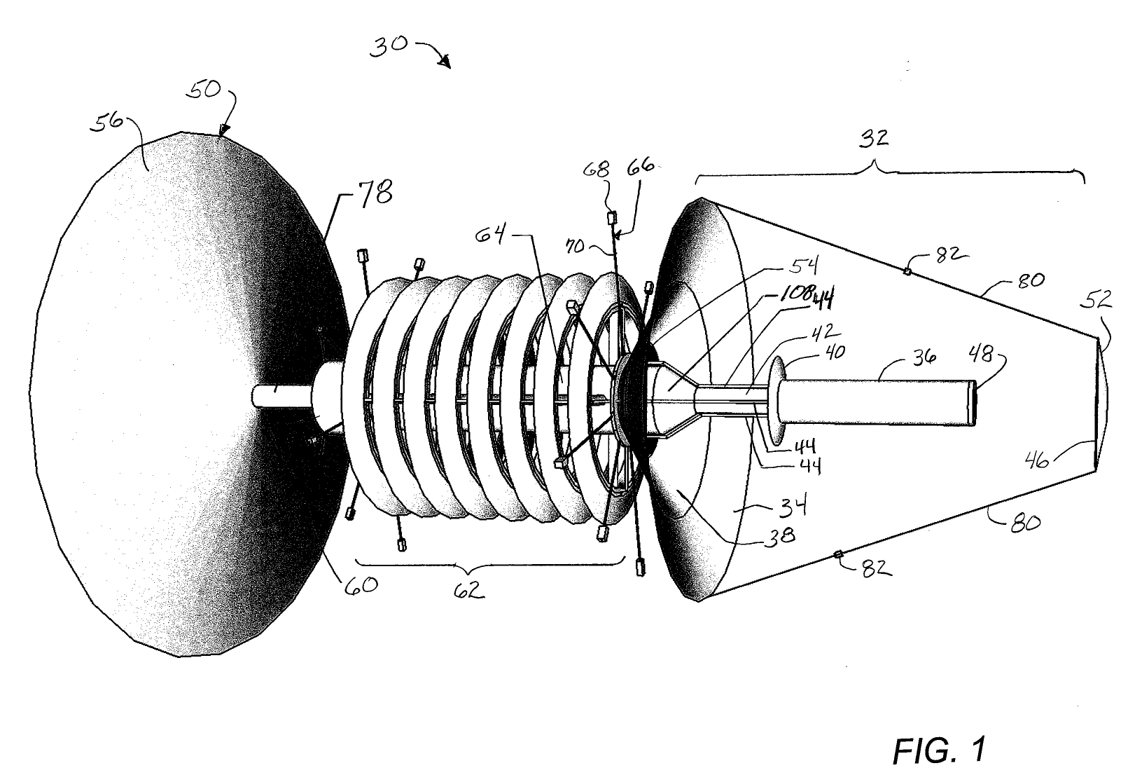

Referring now in more detail to the exemplary drawings for purposes of illustrating embodiments of the invention, wherein like reference numerals designate corresponding or like elements among the several views, there is shown in FIG. 1 a frontal perspective view of an orbiting power plant 30 for generating electrical energy in a micro-gravity environment according to aspects of the invention. Although not shown, a solar radiation source would be located to the right side of the figure for providing solar radiation to the power plant. One obvious solar radiation source is the sun and in that particular application, the orbiting power plant 30 would be orbiting the earth. The terms “power plant,” “power generating system,” “power generating satellite,” “space craft,” and “space vehicle,” are used interchangeably herein and are meant to be descriptive of an embodiment or embodiments, and not meant to be limiting.

For convenience, in the following detailed descriptions of embodiments, various abbreviations are used. At an abbreviation's first use, a meaning is given. However, a table of abbreviations has also been included at the end of this section for convenience.

The orbiting power plant 30 in accordance with aspects of the invention provides solutions to the problems mentioned in the Background section. Each problem is pointed out in detail below along with the solution to overcome that problem. As was noted previously, some of the problems discussed did not appear to be appreciated by those operating in the field heretofore.

FIGS. 1, 2, and 3 provide an external viewpoint of many of the systems in the orbiting power plant 30. The differences between the embodiments of FIGS. 1, 2, and 3 will be discussed in detail below. However, at this time, their similarities are discussed.

A radiation collection system 32 comprises a combination parabolic reflector/shield 34. The reflector 34 faces the solar radiation source such as the sun, collects radiation, and then reflects that collected radiation, either directly or indirectly, to a predetermined position 36 at which a Rankine-type engine having a working fluid extracts that reflected radiation to change the working fluid from a liquid state to a gaseous state. In one embodiment, the working fluid is water and at the predetermined position is the boiler 36. A mirror array 38 inside the reflector 36 is configured to focus radiation on a preheat reflector 40 that directs the radiation to the steam line 42 that conducts steam to turbines, as discussed later, and to working fluid feed lines 44. The preheat reflector provides continued heat to the steam to assist in retaining it in the steam state, and preheats the supply or feed lines 44 in which liquid water flows to the boiler 36. The reflector/shield 34 and the mirror array 38 shield everything behind themselves from direct solar radiation, with the exception of portions of the transmitter antenna 50.

A front concave or parabolic mirror 46 (see FIGS. 1 and 3-6) focuses the collected and reflected radiation from the reflector/shield 34 onto the end 48 of the boiler 36 and shields the other components located in front of the reflector/shield 34 and the mirror array 38 from direct solar radiation. In designing the embodiments of FIGS. 1, 2, and 3, care has been taken to provide shields to protect specific components from receiving solar radiation for various purposes, as is discussed below. The front side 52 of the front concave mirror 46 includes a photovoltaic surface to generate power for batteries for system operation (e.g., fluid pumps, valve solenoids, processors, communications, motors, etc.). A ring of photoelectric sensors 54 located just inside a shadow formed by the front concave mirror 46 (shown as a blackened or shadowed area on the mirrored array 38) provides input to rotational balance control micro-processors (not shown), for achieving alignment of the power plant 30 with the solar radiation source so that the reflectors shield the power plant components meant to be shaded. The sun side surface 56 of the transmitter antenna 50 outside the shaded area produced by the reflector/shield 34 provides another location for photovoltaic surfacing for system operation.

FIGS. 1, 2, and 3 also show a transformer 60, a cooling system 62, the fuselage 64, and a rotational balancing system 66 in which masses 68 are moved along poles 70 to balance the rotation of the orbiting power plant 30. The masses can be positioned and repositioned (e.g., by motors and cables) and are controlled by microprocessors programmed for rotational balance. The masses may be attached to telescoping poles from the fuselage and/or spooled high-tension wire or fiber. Some may be attached to the generator shaft, as discussed below, and therefore rotate in the opposite direction from those attached to the hull. The microprocessor or microprocessors obtain input as to rotational attitude from the photo sensors 54 that detect direct solar radiation. Even though only one mass 68 and one pole 70 are indicated by drawing numerals, this was done for clarity in the figures. It is intended that the numerals 68 and 70 indicate all masses and poles that are shown. The masses and poles are intentionally shown asymmetrical in the figures, as they would likely be in actual operation.

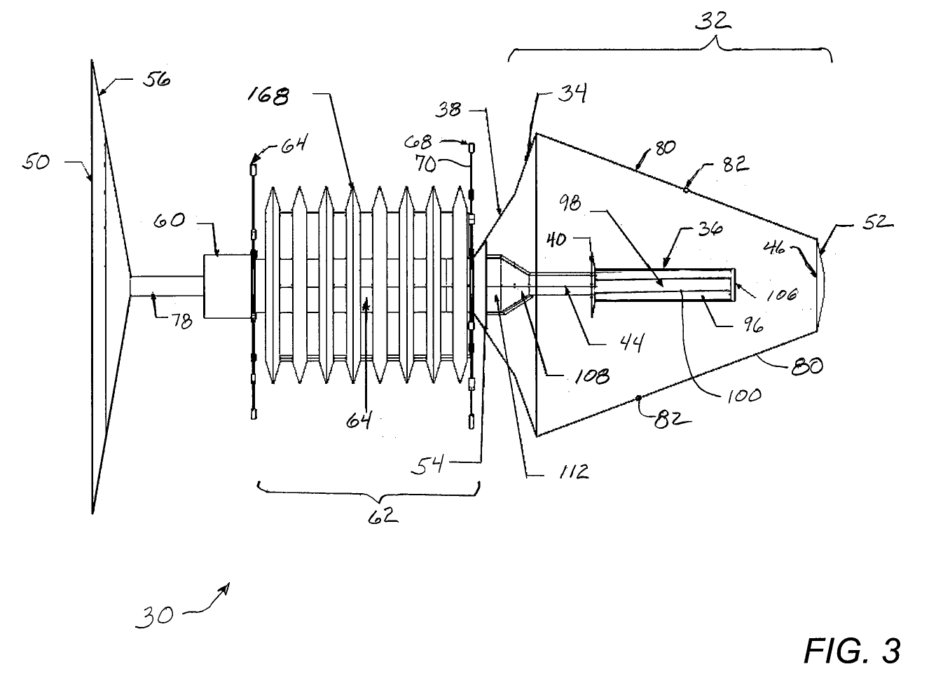

The fuselage 64 is shown connected with the transmitting antenna 50 by the shaft 78. This is not intended to be limiting and in actual practice there may be an array of transmitting dishes used. Referring now to FIGS. 1 and 3, structural components 80, such as mounting poles, include motors and relays for rotating the front concave mirror 46 by 180° to face the sun. This rotation moves the reflector 46 out of position in relation to the boiler 36 thereby serving as an “off” switch for the steam generation cycle. The mounting poles also include masses 82 that may be positioned and repositioned to provide rotational balance of the orbiting power plant 30. The transmitter antenna 50 has dual capability for directional or wide broadcasts in this embodiment. The transformer 60 is tunable and is capable of providing microwave frequencies from the electrical energy generated by the orbiting power plant 30. Additionally, the transformer may also make other changes to the characteristics of the transmitted energy for the purpose of interacting with atmospheric green house gases to change their composition or otherwise render them less harmful; i.e., transparent to infrared radiation.

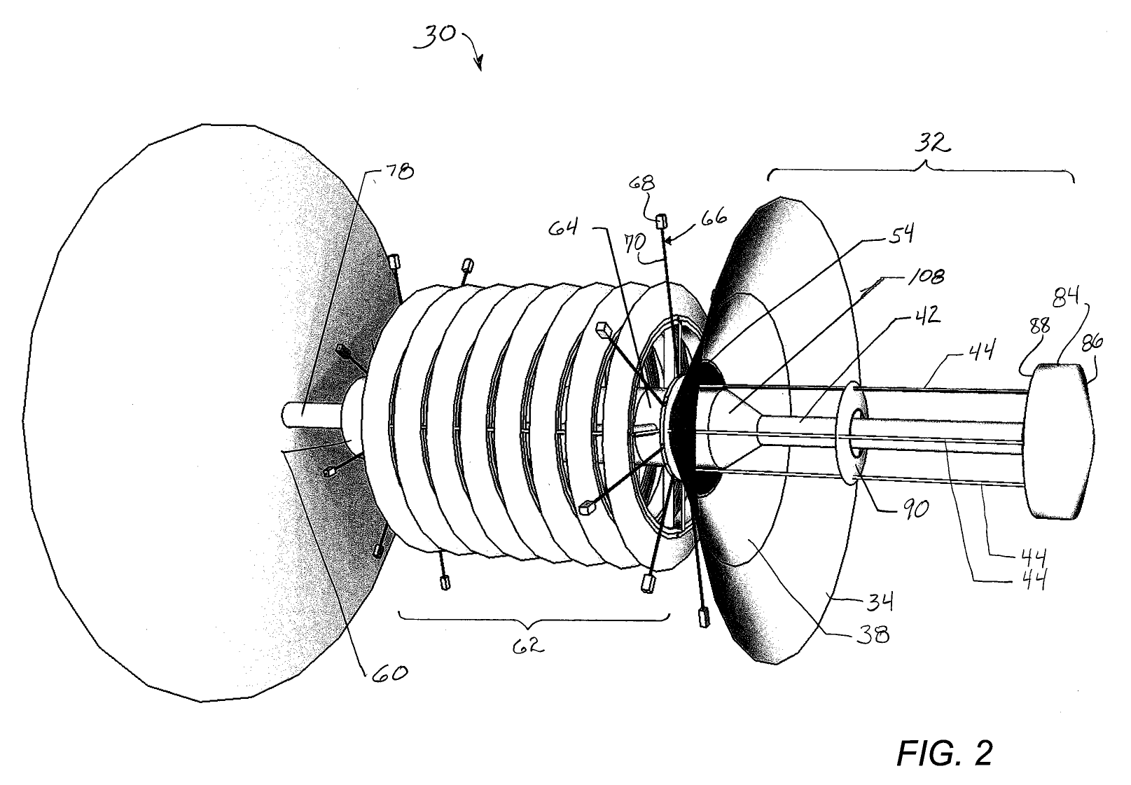

Referring to FIG. 2, a boiler 84 is mounted at the frontal end of working fluid feed lines 44 and at the frontal end of the steam feed line 42. The boiler directly receives solar radiation on its front side 86 and receives radiation reflected to it from the reflector/shield 34 on its rear side 88. A secondary reflector 90 focuses radiation reflected by the mirror array 38 onto the steam line 42 and the water feed lines 44 for the same purposes as desired in regard to the FIG. 1 embodiment. (The boiler in this embodiment is intended to have a greater radius than the boiler in the embodiment shown in FIG. 1, enabling liquid/gas separation to be achieved at slower hull rotation velocities). Other than the above changes, the embodiment of FIG. 2 is similar or identical with that of FIG. 1.

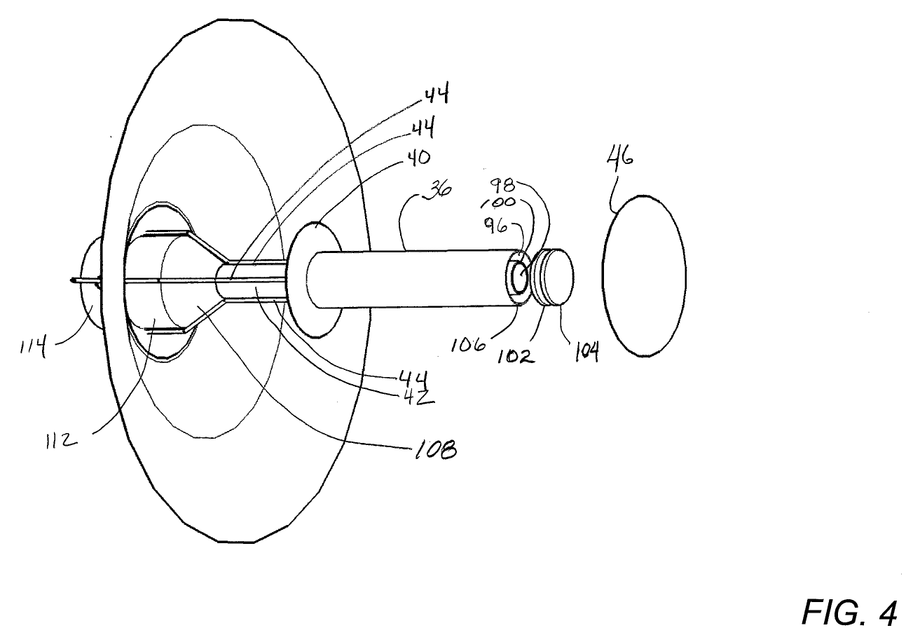

Turning now to FIGS. 3 and 4, pressurized working fluid is provided to the feed lines 44 and to the boiler 36 by fluid pumps (not shown). These pumps may be located on the rear side of the mirror array 38 or elsewhere, depending on various factors. The boiler 36 outer chamber 96 contains pressurized working fluid (e.g., water) in the liquid state, which raises the boiling point of the working fluid (water) and prevents vapor from forming pockets within the boiler 36. The inner chamber 98 of the boiler 36 is constructed of a micro-porous membrane material allowing gaseous ions (hydrogen and oxygen) to pass through to the inner chamber but not liquid (water). In the event of the alternative use of the orbiting power plant, a second chamber (not shown) located as part of the boiler permits hydrogen to pass through but not oxygen. This separation of the two could be used for producing hydrogen gas for fuel cells and oxygen for breathing.

The micro porous material of the inner chamber 98 of the boiler 36 is similar to a reverse osmosis membrane. The micro-pores are sized to permit the gaseous (ionic) form of the working fluid into the volume of the inner chamber while excluding the working fluid in liquid form from entering. As the pressurized working fluid in the liquid state absorbs thermal solar energy, it changes to the higher-energy gaseous state. As is described in some detail below, the gaseous and liquid forms of the working fluid are separated from each other by the establishment of a pseudo-gravity environment in the hull that is caused by centrifugal force resulting from rotating the hull of the orbiting power plant 30. The centrifugal force establishes a buoyant force environment. Once inside the inner chamber 98, the higher-energy gaseous phase of the working fluid would be forced by vapor pressure to move into the manifold 108. This is ensured by continually replenishing the working fluid in the boiler with additional lower-energy liquid state of the working fluid sufficient to prevent a lowering of density of working fluid.

Although not intending to be bound by theory, it is believed that in principle, the vapor pressure of the higher-energy gas state of the working fluid would have to exceed the force required to compress the liquid form of the working fluid in order to not go into the inner chamber 98 of the boiler 36.

It is expected that the available energy from reflected solar radiation would be sufficient to raise the temperature of the pressurized working fluid above its boiling point, thereby superheating the working fluid in addition to changing it to its gaseous form, and increasing the gas pressure of the working fluid that is available for energy conversion.

The lens 102 and filter 104 combination (FIG. 4) located at the front end 106 of the boiler 36 selectively allow radiation from the front concave mirror 46 to heat the working fluid in the boiler and minimize heating the body of the boiler. Steam from the boiler is conducted through the steam line 42 to a manifold 108 which is the point of entry of the steam into turbines 112. The manifold 108 contains the appropriate valves, nozzles, and other equipment to direct the steam (or to provide separate hydrogen and oxygen discharge if for alternate use) to turbine blades to rotate the generator turbine and the hull turbine.

The series of filters 104 and lenses 102 located at the boiler front end 106 is configured to allow specific wavelengths of solar radiation to pass which will be absorbed by the working fluid located inside the boiler, but will not be absorbed by the walls of the boiler itself. Therefore, the filters and lenses optimize the received electromagnetic radiation by passing wavelengths that impart thermal energy to the working fluid and by excluding those wavelengths that would destroy the metallic walls of the boiler. Although shown as two separate components in the embodiment herein, i.e., the filter 104 and the lens 102, these components may take the form of a single device that accomplishes the same result. Other embodiments are also possible.

The boiler outer chamber 96 is kept under pressure by the membrane plate 100, which allows only gas to pass through it to the inner chamber once the liquid is heated to the vaporization point. The inner side of the membrane plate serves as a separate gas chamber 98 where the gas may be super heated. The boiler chamber 98 design is such that the gas expands through turbine generators as the path of least resistance. The resistance of the generator can be set to be just lower than the liquid compression point and lower than the weakest seal of the chamber 98. A valve (not shown) so designed allows the superheated steam through the turbines. An expansion chamber 114 is shown at the left of the drawing that captures steam after it has flowed through the turbines. In a different embodiment, this module may hold water pumps and a reservoir for the working fluid engine.

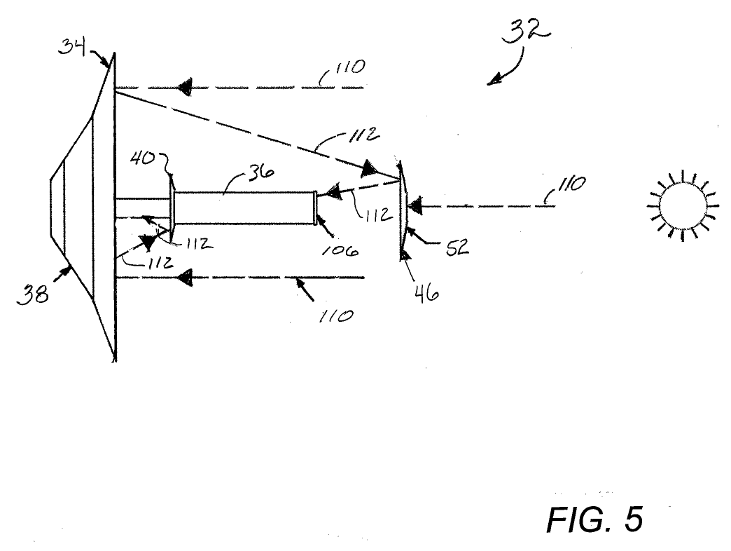

Turning briefly now to FIG. 5, a diagrammatical view is provided of the operation of the solar energy control system 32 showing the operation of the various reflectors in directing solar radiation where needed within the orbiting power plant of FIG. 1. That radiation provides heat needed to create steam to effectively drive an electrical energy generator. The paths of both direct and reflected solar radiation are shown.

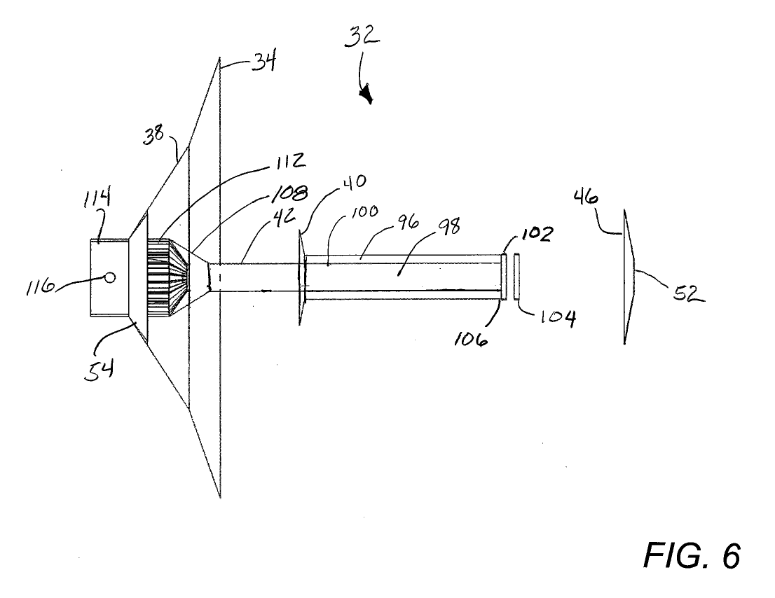

FIG. 6 is a diagram similar to FIG. 4 but with a partial cross-sectional view showing a hull turbine 112 and an expansion chamber 114 that forms part of the Rankine-type engine. The expansion chamber has a steam outlet port 116 in this embodiment, to which a steam tube will be connected for conducting the steam to the cooling system, as described below. The water feed lines to the boiler are not shown.

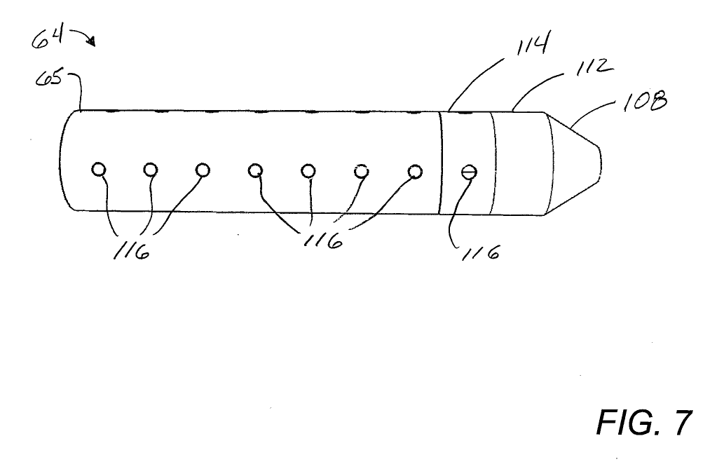

FIG. 7 shows the fuselage 64 hull 65 seen in FIGS. 1, 2, and 3 that houses the electrical energy generator, turbines, and cooling jackets. The manifold 108, turbines' housing 112 and expansion chamber 114 are shown. The figure also shows outlet ports 116 formed in the fuselage outer jacket or hull for permitting passage of the working fluid in gas form from the turbines to the cooling system. These ports 116 may also be used, by means of proper connection to respective jackets, for the passage of a refrigerant that is used to cool the generator.

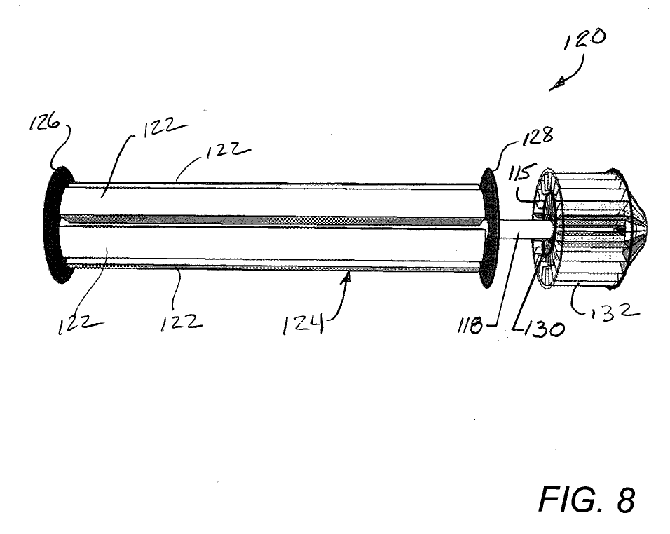

FIG. 8 shows part of the electrical energy generator 120 including rotating magnets 122 forming a part of the rotor 124, seals 126 and 128 at each end, and a pair of co-located turbines 130 and 132 at the right side, each of which has a plurality of angled blades. The inner turbine 130 is fixedly mounted to the rotor shaft 118 so that turning the turbine 130 causes rotation of the shaft 118 and magnets 122. The outer turbine 132 is fixedly attached to the hull of the orbiting power plant so that turning the outer turbine causes rotation of the hull, reflectors, cooling system, boiler, and other components. The blades of the outer turbine have an opposite angle, in this embodiment, to the blades of the generator turbine. Thus, applying steam to both turbines through the manifold 108 of FIG. 6 will cause the generator turbine to rotate in a first direction and the hull turbine to counter-rotate in the opposite and second direction. The amount of steam applied to the hull turbine can be controlled in one embodiment to achieve only as much counter-rotation of the hull as necessary to overcome a tendency of the hull to rotate with the generator rotor and to achieve the pseudo-gravity environment in the hull 65. In another embodiment however, the amount of steam applied to the hull turbine is sufficient to cause it, and the hull, to rotate in the opposite direction to the generator rotor.

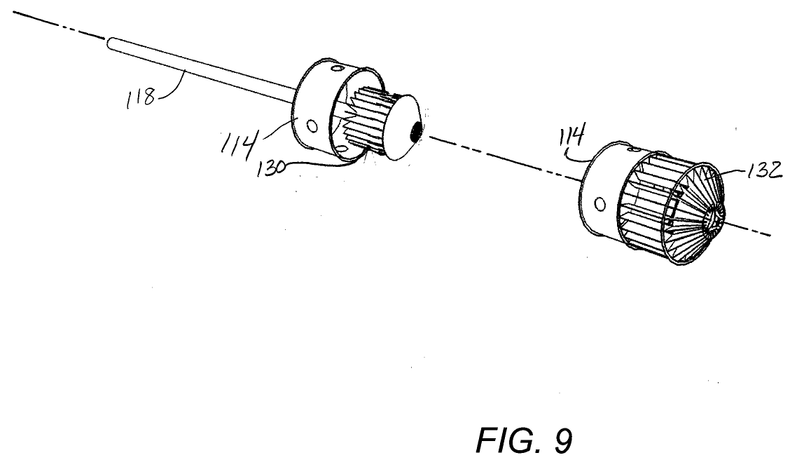

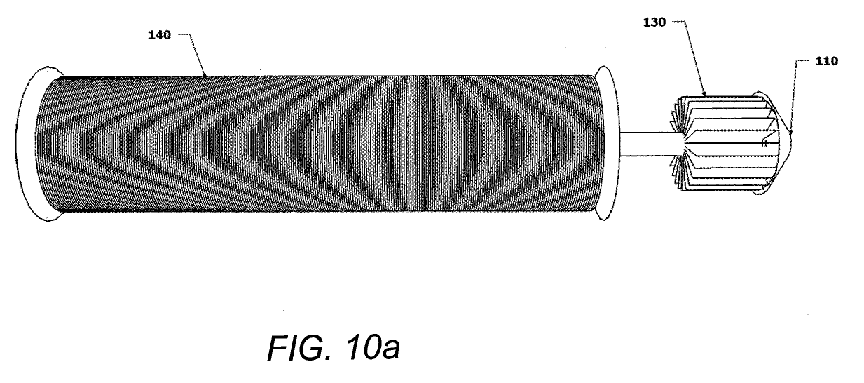

FIG. 9 is an exploded view of the turbines 130 and 132 of FIG. 8 showing the inner or generator turbine 130 for causing rotation of the generator rotor 124 with magnets 122 as shown in FIG. 8, having the expansion chamber 114 directly behind the generator turbine for channeling the steam away from the generator once it has applied rotational force to the turbine. The hull turbine 132 provides rotational force to the hull of which the generator coils form a part. The same expansion chamber 114 is also located behind the hull turbine 132 (since the turbines are co-located in this embodiment) for channeling the steam away from the hull turbine once it has applied turning force to the turbine thus, although shown as two expansion chambers, there is only one (114). Although not shown, in detail, the generator turbine fits inside the hull turbine and they are separated from each other by a wall 115. The manifold 108 (not shown) may contain shaped cowls or barriers or hull wall components or sleeves, also referred to as separator cones 110 in FIG. 10a, that are attached to the hull and separate the steam going to each turbine. The separator cones can also act as guides to direct the steam onto the turbine blades by use of internal flutes.

FIGS. 10a and 10b are views of the electrical energy generator 120 showing the rotor 124 having magnets 122 and the generator driver turbine 130, and also showing, in FIG. 10a and partially shown in FIG. 10b, the outer coils 140 that encase and surround the rotor 124. FIG. 10a shows seals at either end of the coils while in FIG. 10b, the front bearing has been removed for clarity in seeing the magnets. The generator turbine is fixedly connected to the magnets on the shaft 118. Although not shown in either figure, the coils 140 are attached for rotation with the hull 65 and the rotor 124 rotates in the opposite direction for the generation of electrical energy.

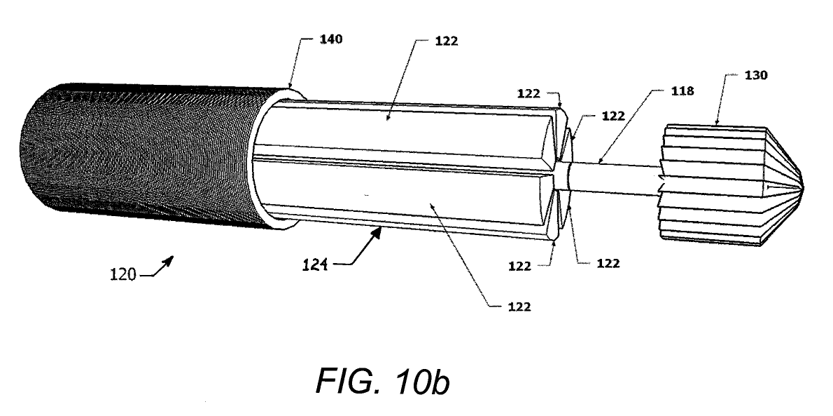

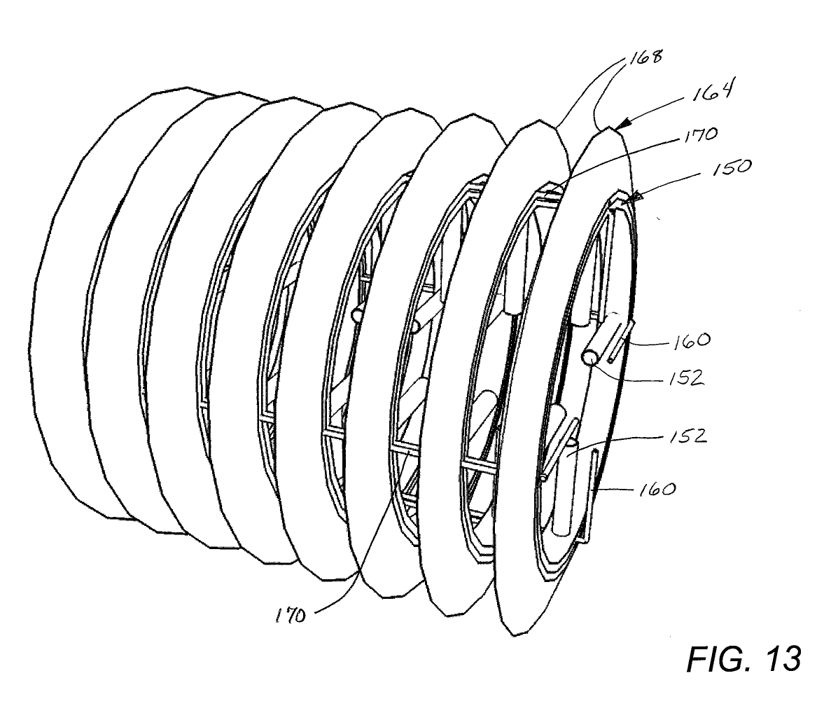

The electricity generator 120 of the most suitable type for a microgravity environment may include the toroid magnets used (not shown) as frictionless bearings. The expansion of the heated gas (steam) provides the kinetic energy necessary to rotate the generator turbine 130. Some of the energy of the gas is dissipated in the process, beginning the cooling phase of the circulating working fluid. Once the gaseous working fluid has been applied to the turbines 130 and 132, it is then channeled to the expansion chamber 114 which is connected with a working fluid jacket within the fuselage, which will be shown and described in connection with FIG. 14. Concentrating now on FIG. 11, a steam cooling system 150 is shown, which is part of the overall cooling system 62 in FIG. 1. Connected with the fuselage working fluid jacket (not shown) is a plurality of steam inlets 152. These steam inlets conduct steam from the fuselage to a set of eight (in this embodiment) steam-to-water condensation rings 154. Providing structural support and interconnection between each condensation ring are four condensation interconnection tubes 156. Steam enters the steam inlets 152, flows through the condensation rings and condensation interconnection tubes transferring heat (to refrigerant, as described below) and then returning to the lower-energy state of water (liquid state). Four water outlet tubes 160 at the right-most condensation ring 154 provides water resulting from the operation of the cooling system 150 to water pumps (not shown) for recirculating the recaptured water to the boiler (see FIG. 1). In another embodiment, the recaptured water may be returned to a storage/reserve tank, or reservoir, until needed by the boiler.

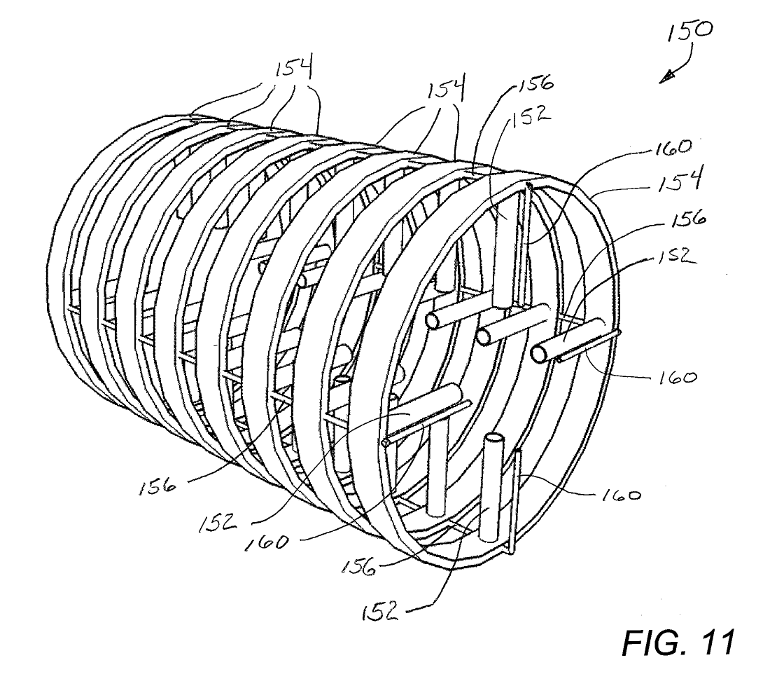

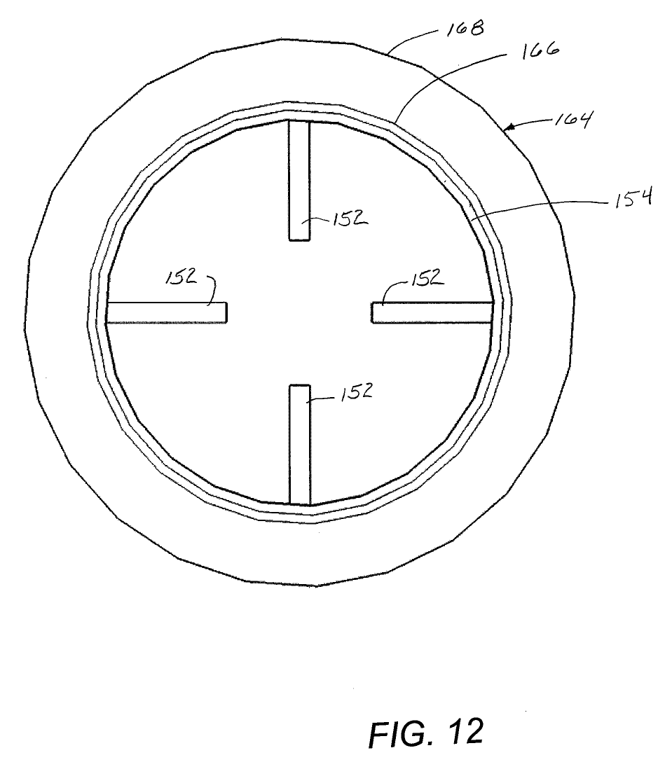

Referring now to FIGS. 12 and 13, assisting the steam cooling system 150 shown in FIG. 11 is a refrigerant system 164 used to conduct heat from the steam. The refrigerant cooling system comprises a refrigerant inner sleeve 166 and an outer refrigerant ring 168. The inner refrigerant sleeve 166 is in contact with a steam condensation ring 154 to extract heat from the steam. The refrigerant system 164 radiates the heat into the near infinite heat sink of outer space, as the cooling system 62 is positioned behind the reflector/shield 34 (see FIG. 1). The cooling system thus provides cooling for the steam and cooling for the refrigerant both. In one embodiment, ammonia may be used as a refrigerant although various media may suffice as a refrigerant.

The outer material of the refrigerant system 164 rings 168 may be made of shuttle tile material or of whatever material provides the fastest heat transfer by radiation. The steam condensation rings 154 are kept under negative (vacuum) pressure internally to move condensed vapor (lower-energy liquid state) of the working fluid either into a reservoir, or may be directly cycled to the boiler via pumps. The liquid working fluid from these tanks is then pumped into the boiler 36 as needed to provide a continuous supply of working fluid medium for phase change and expansion. In this embodiment, the entire cooling system 62 is attached to the hull 65 of the orbiting power plant and all rotate together, as required to provide a pseudo-gravity system in the boiler to separate the higher-energy gas state of the working fluid from the lower-energy liquid state of the working fluid.

The outer cooling system 62 including the steam cooling system 150 and the refrigerant cooling system 164 can be seen in FIG. 13 in a side perspective view. In this view, a few refrigerant circulation lines 170 are visible that interconnect the refrigerant rings 168. As with other interconnecting lines, there are four of these and they are symmetrically spaced. It should be noted that the use of four lines is for one embodiment only. Rotational stability of the cooling system is a priority and symmetry of components is desired. However, fewer or more than four of the lines may be used and symmetry or balance still achieved.

Referring now to FIG. 14, a cross-sectional view of the fuselage 64 is shown. At the center is the rotor shaft 118 which is surrounded by the rotor 124. Details of magnet mounting and shapes are not provided so that clarity of the diagram can be preserved. The next layer includes the coils or stator 140 of the generator. Surrounding the coils is a refrigerant jacket 180 through which refrigerant flows to remove heat produced by the electrical energy generator. Located about the refrigerant jacket is a steam jacket 182 into which steam flows after leaving the expansion chamber 138. A representative steam inlet 152 is shown connected with the steam jacket 182 for conducting the steam out of the fuselage for cooling 150. Also, within the steam inlet is a refrigerant inlet 153 interconnecting the refrigerant jacket 180 with the refrigerant cooling system 164 for cooling the refrigerant. Details of interconnections of such tubing with jackets are within the skill of those in the art and no further details are provided here.

It should further be noted from FIG. 14 that the shaft 118 and rotor 124 of the generator may rotate in a clockwise direction as shown by arrow 186 while the coils 140 and two jackets (and associated external cooling systems) may rotate in a counter-clockwise direction as shown by arrow 188. In this embodiment, the two jackets 180 and 182, external cooling systems 150 and 164, boiler 36, reflectors 34 and others, and other equipment may be thought of as the hull 65. This rotation of the hull, of which the boiler is a part, permits the creation of a pseudo-gravity environment due to the creation of centrifugal force. In such an environment, the buoyancy force is established in which the more dense (heavier) lower-energy liquid state of the working fluid will tend to remain toward the outer wall of the boiler while the less dense (lighter) higher energy gas state of the working fluid will tend to move towards the center of the boiler, through the membrane 100 (see FIG. 4).

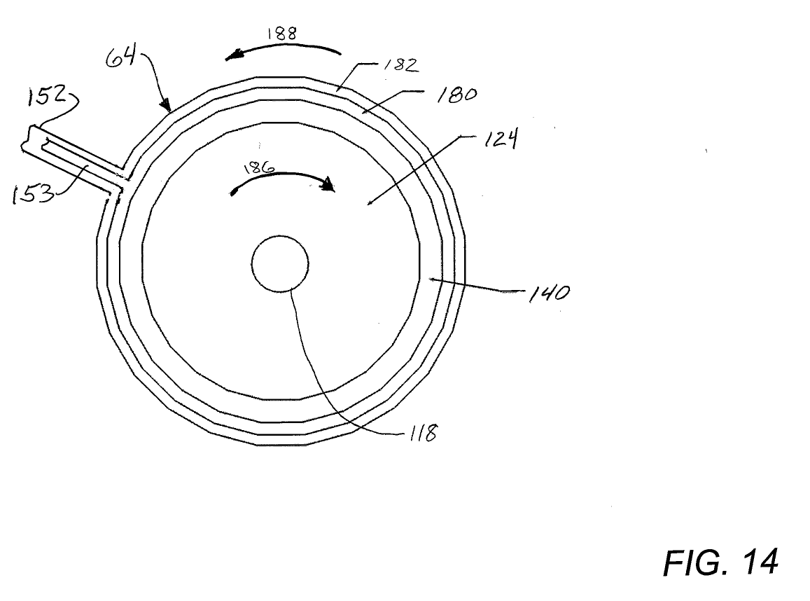

Referring now to FIG. 15, a brief description of the Rankine-type engine with water as the working fluid is presented. Solar radiation, indicated as “Q-in” is applied to a boiler C3. The applied Q-in solar radiation is expected to provide constant heat energy equivalent to the solar constant (1.4 kW/sqm or 429 BTU/hr/sqft). The interior surface of the boiler C3 may have a reflective coating to contain the solar radiation or may have semi-transparent walls as determined necessary to optimize the temperatures of components in the shaded area between the reflectors by permitting some solar radiation to escape through the walls of the boiler C3, in addition to any radiant heat from the boiler C3. The working fluid is introduced to the boiler C3 in a lower-energy liquid state. As gas is formed in the boiler, a separator C4 separates the higher-energy gas state of the working fluid from the liquid state.

That higher-energy working fluid is then applied to turbine 1 and turbine 2 so that they may each perform mechanical work W-1 and W-2 respectively. In this case, they are used to rotate the rotor of an electrical generator to generate electrical power and to rotate the hull of the orbiting power plant to establish a pseudo-gravity environment. The gas that passes through the turbines is then channeled to the cooling system, indicated as blocks E1 through E3. Blocks E2 and E3 indicate the refrigerant cooling system that provides heat transfer from the steam (block E1) to the ammonia. Ammonia does not mix chemically with water or steam; hence, it is kept separate and not mixed with the working fluid. Heat from the steam E1 is transferred to the ammonia E2 and the ammonia is circulated back through the rings E3. Ammonia is used because it has a lower freezing point than water, is a suitable heat conductor, and readily releases excess heat. Although two different fluids are used in this embodiment; i.e., water and ammonia, other embodiments may be possible where more, or fewer, fluids are necessary to accomplish the desired result. Additionally, various other fluids may be used as working fluids and refrigerants other than water and ammonia.

After the higher-energy steam state of the working fluid is cooled, thereby releasing energy “Q-out” and returning the working fluid to the lower-energy liquid state, it is returned to the reservoir C1. When needed again for the cycle, the working fluid is pumped and pressurized by the pump C2. The indication “W-p in” means that energy must be added to this part of the cycle.

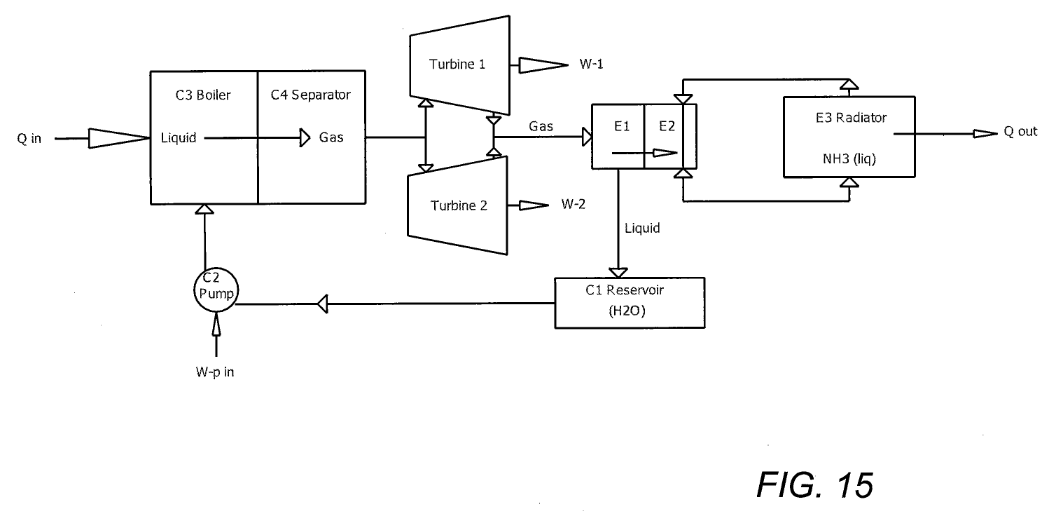

FIG. 16 is a schematic diagram of the flow of power through the orbiting power plant of FIG. 1 showing solar radiation SOL being received at the left. Direct solar radiation DSR is received by the reflectors 34 and 38 which then produce reflected solar radiation RSR. In the case of reflector/shield 34, the RSR is directed to another reflector 46 to develop focused solar radiation FSR onto the boiler 36. However, a lens 102 and filter 104 refine the solar radiation to optimized solar radiation OSR. The OSR causes the lower-energy liquid state working fluid in the boiler 36 to absorb the heat from that OSR radiation and change to a higher-energy gas state working fluid and move to the inner chamber 98 of the boiler. The working fluid is then directed through the manifold 108 in which various valves, restrictors, nozzles, separator cones, and other necessary devices may exist to direct the steam to the blades of the hull turbine 132 and the generator turbine 130 to result in rotational and counter-rotational motion as indicated by the two circular arrows 130 and 132. The higher-energy gas state working fluid is then cooled 62 and returned to the boiler 36 through feed lines 44 when needed. Electrical energy generator 200 produces electrical energy conducted to a transformer 60. The transformer may be used to transform the electrical energy into two energy streams, one to a wide-angle antenna 202 and one to a directional antenna 204, for wireless transmission to multiple targets (wide broadcast would be for molecular decomposition in the atmosphere, directional would be for energy transmission ultimately to rectannae). The transformer 60 may also transform the electrical energy from the generator 200 to different forms, such as to microwave form. Although “X GHz” (where “X” represents variable frequencies that would be chosen according to the specific molecule to be targeted) and 2.45 GHz are shown in the drawing, other forms may be produced.

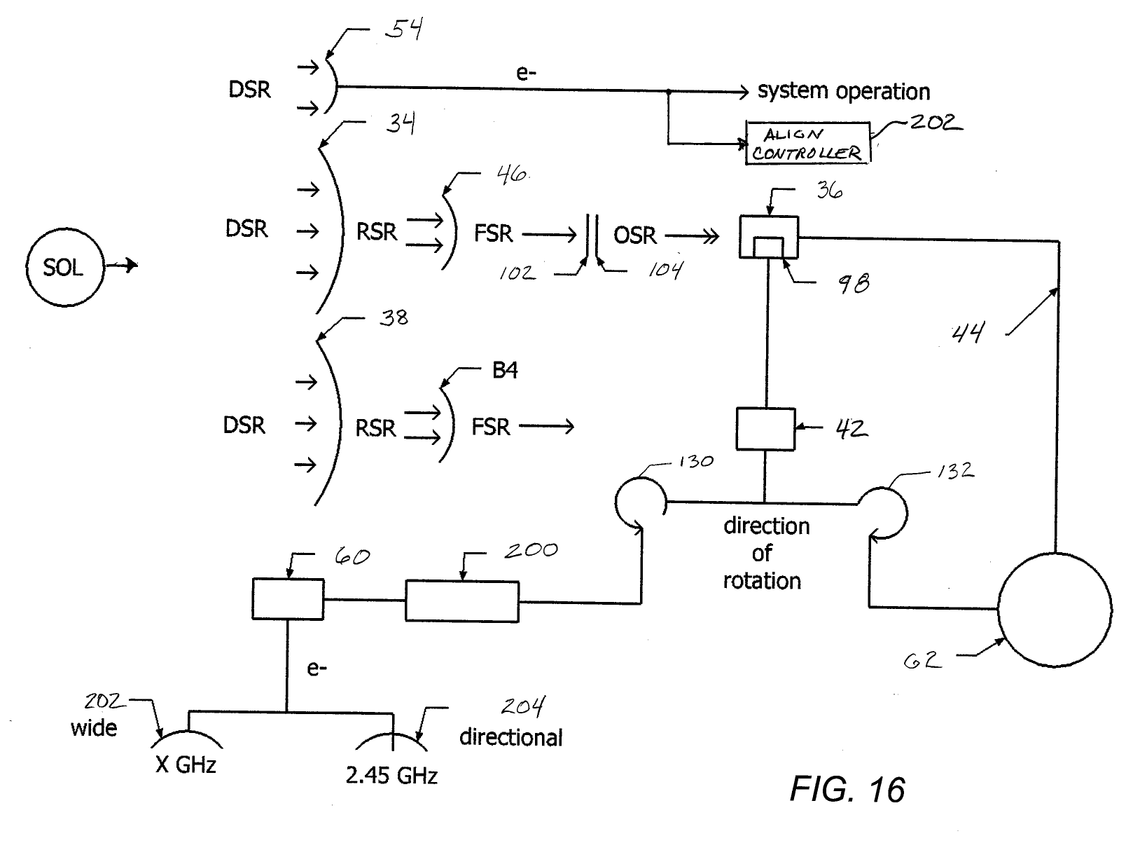

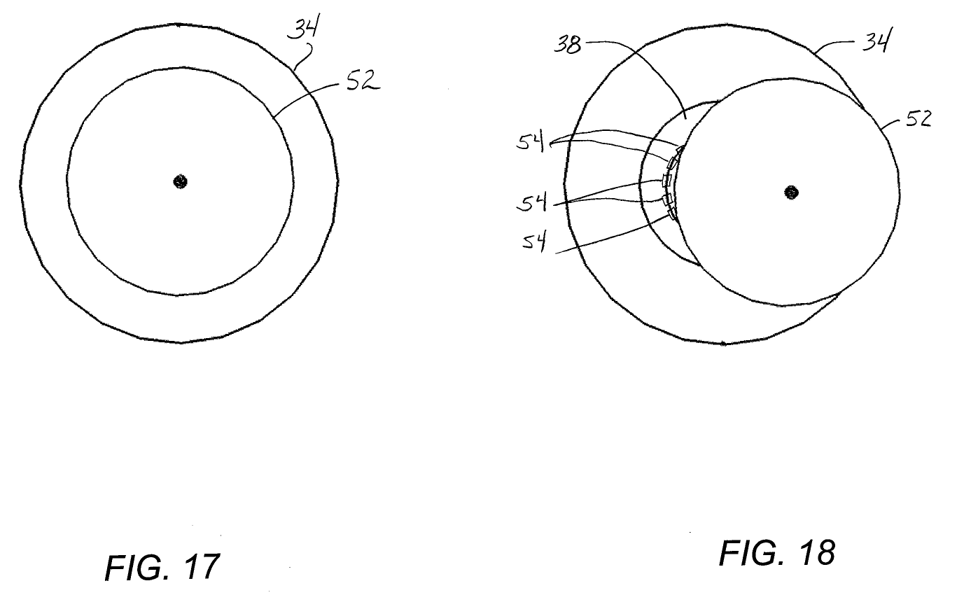

FIG. 17 is a drawing showing the orbiting power plant of FIG. 1 in alignment with a solar radiation source so that the solar radiation reflectors operate efficiently as designed. The attitude of the spacecraft in relation to the solar radiation source can make a great difference in its efficiency. Being aligned with the solar source or with a radial of that source results in the best performance. The collection system will function properly and the shields will also provide the desired protection for certain components. In particular, the large reflector/shield 34 of FIG. 1 and the front concave mirror/photovoltaic array 46/52 receive direct solar radiation. These two devices likewise shield other components between them and behind them from receiving direct solar radiation. Thus, the cooling system 62, which is behind the large reflector/shield 34 is shielded from direct solar radiation that would otherwise impair its ability to cool the working fluid and the refrigerant. FIG. 18 on the other hand shows the orbiting power plant of FIG. 1 misaligned with the solar energy source such that direct solar radiation will strike along the body of the orbiting power plant and yield the solar control reflectors/shields only partially effective.

Examining FIG. 18 in more detail shows that the mirror array 38 is visible as well as a ring or the array of photo sensors 54 located inside the mirror array 38 and just inside a shadow that would be formed by front reflector 56. If these photo sensors detect direct solar radiation, their outputs are used by the alignment controller 207 to adjust the balancing system of masses and poles to return the orbiting power plant to an aligned attitude, as shown in FIG. 17.

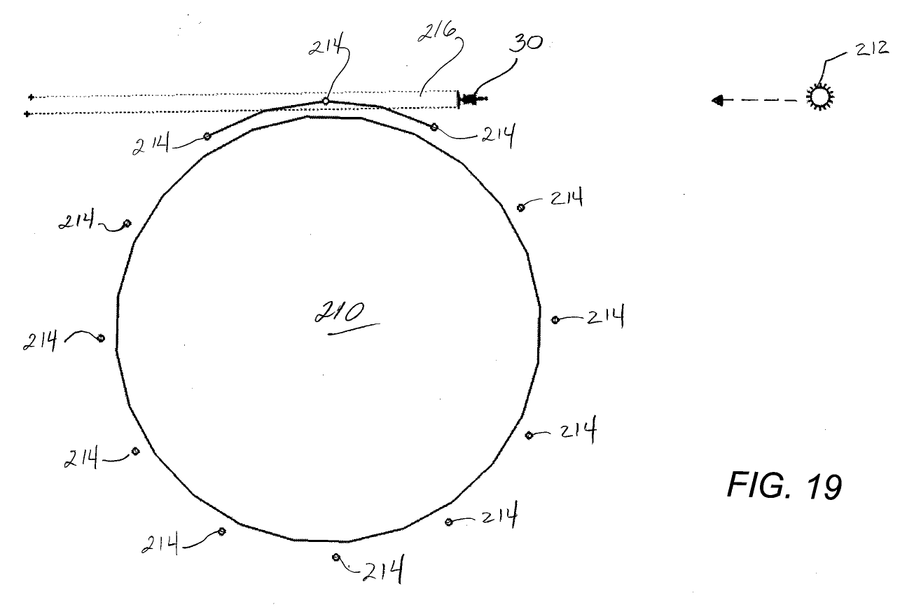

FIG. 19 is a diagrammatic view of the operation of an orbiting power plant 30 in accordance with FIG. 1 which is in a fixed, non-geosynchronous orbit over the earth 210 and is in alignment with the sun 212. A plurality of geosynchronous relay satellites 214 have been placed over selected positions of the earth for relaying electrical power produced by the orbiting power plant 30 to selected power grids on the surface. As shown, the orbiting power plant 30 wirelessly transmits the electrical power it generates in a beam 216. As the relay satellites enter the beam 216, they may use and/or re-transmit the electrical power to the surface of the earth. Judiciously positioning the array of relay satellites over the earth so that one after another comes into the beam of the orbiting power plant can result in continuous use of the electrical energy produced. Just as the relay satellite shown in the beam 216 begins to move out of the beam, another enters the beam. The relay satellite(s) within the beam could then “bounce” the energy along the array of relay satellites to that particular one which is geosynchronously positioned over a surface receiving station, at which point that relay satellite would direct the energy to the earth station.

The embodiments above indicate water as an acceptable working fluid. Other fluids may also be usable however. The actual chemical composition of the working fluid must have specific characteristics; e.g., the molecules of the liquid state of the working fluid must be larger than the ions of gas state of the working fluid. Recombination of the gas ions of the working fluid should form the liquid state of the working fluid without secondary reactions (intermediate states) and without the need for catalysts. Physical properties must be such that evaporation and condensation occurs within the ranges of operation in the space environment; i.e., temperatures ranging between lows of −250° to −150° C., and highs of 3000-6000° C. (estimated) with phase changes to the solid state avoided within controlled operational ranges.

### Operation

Solution to Problems 1 and 2—Force Induced by Rotation—The lack of buoyancy is resolved in this design by using what is commonly understood as centrifugal force to stratify liquid from gas during vaporization. Fluids in a centrifuge behave similarly to fluids in a gravitational field in that they stratify according to density. In practice, centrifuges provide force sufficient to negate the effects of gravity, causing stratification to occur horizontally (perpendicular to the centerline of gravitational force). By applying a sufficient directional force, buoyancy and convection result. In the present design, this is accomplished by rotating the entire power plant 30, thereby rotating the boiler 36. It should be noted that less rotational force would be required in space to produce stratification as is required on earth since relatively strong gravity does not have to be overcome. The way this rotation is accomplished also leads to a solution to the second problem arising from Newton's Third Law in a microgravity environment; i.e., for every action there is an equal and opposite reaction.

Solution to Problem 3—Rotational Force in the Opposite Direction—Simply explained, the design includes rotating a generator shaft with attached magnets (rotor) inside of a coil assembly (stator) using a steam powered turbine. The rotor would be mounted via sealed bearings and rotate with the turbine independently of all other parts of the satellite. The stator would be rigidly attached to the satellite hull and rotated with the satellite in the opposite direction as the rotor. The force used to rotate the stator (and fuselage) would be steam produced from the same boiler which produces the steam for the rotor turbine. To accomplish this, two separate turbines are used. Turbine design, manipulation of steam, and electrical current generators are well developed common practice technologies and are not otherwise detailed here.

It may seem counter-intuitive to have steam rotating the same boiler which generates it; but note the steam itself is not rigidly attached to the boiler or either turbine. The expansion of the superheated gas is the source of energy applied mechanically as torque, which is to be directed through turbines designed to rotate in the necessary directions. In the submitted design, the fuselage (including the boiler, pipelines, manifolds, jets, and the remainder of the satellite except the rotor and rotor turbine) would be attached to one of the turbines (fuselage turbine). There is more than one way to accomplish this connection, it could be a rigid attachment with rotational velocity governed by thermodynamics, or by transmission gearing. The important principle here is that the rotational velocity of the fuselage must provide sufficient force to stratify the gas and liquid in the boiler while providing the force required to counter the internal resistance of the generator. It is a serendipitous feature of this design that the rotational velocities of both turbines are additive when calculating the generator rpm, even though they are turning in opposite directions.

It should be briefly stated here that mass balance and distribution of torque from the fuselage turbine are critical mechanical factors in this design, since it is necessary that the rotation occur around an oriented fixed axis. Such engineering specifics are within the scope of existing technology and practice but beyond the scope of this document. However, it is understood that a continuous dynamic balance of the fuselage would have to be achieved in order to maintain orientation around a specific fixed axis, particularly due to constant fluid movement within the satellite. Therefore, a unique system for detecting and correcting rotational imbalance as it may occur is included in this design.

Solution to Problem 4—Conductive Heat Transfer and Radiant Heat Discharge—The First Law of Thermodynamics describes a property which fortunately appears inherent to all matter. For the present purpose this means whatever is hot will emit energy to the surrounding environment if that environment is less hot, occurring as thermal radiation in outer space. Materials absorbing undiffused solar radiation have been measured to have temperatures between 250 and 6000 degrees C. The temperature on the shade side of a rock on the moon, and the shade side of the International Space Station (ISS) has been measured to be −250 degrees C. Absence of atmosphere allows an extreme temperature gradient to exist which facilitates a higher rate of heat transfer by radiation. The word “transfer” is somewhat misleading, but radiant heat transfer persists as an esoteric term for the process. A cooling system based on this principle is included in the submitted design. The principles are applied in a unique way to accommodate specific requirements of the intended purposes.

The satellite described herein is intended to continuously absorb direct solar radiation; therefore, measures are incorporated in the design to shield all parts of the satellite which do not need to be exposed. The means to regulate and optimize temperatures of all internal working components become available as operational by-products of both the Rankine cycle and the design method of utilizing solar radiation. Additionally, continuous rotation of the power plant is possible through use of the hull turbine so that direct solar energy (“DSR”) will be evenly distributed thereby preventing the DSR from concentrating on a single location.

Abbreviations used herein have the meaning as follows:
DSR—direct solar radiation
EM—electromagnetic radiation
FSR—focused solar radiation
GETM—gaseous energy transfer medium
ISS—International Space Station
LEEM—liquid energy exchange medium
NASA—National Aeronautics and Space Administration
OSR—optimized solar radiation
RSR—reflected solar radiation
SGETM—superheated gaseous energy transfer medium

Solid fuel rockets or steam purge jets may be used for positioning and orientating the satellite. Existing technology may be used for communication and operation of the satellite. Photovoltaic panels could be used to provide power for operation of needed pumps, motors, solenoids, microprocessor, communications, etc. It is believed reasonable to expect to develop power generation satellites as described so as to operate unmanned and controlled remotely for at least a decade. Satellites could be placed on a schedule of maintenance based on performance and maintained routinely from the International Space Station.

Various techniques may be used to start, or restart, rotation of the hull to establish the buoyancy force. Compressed gas, solid fuel rocket propellant, or heated gas from a small tank exposed to the sun (for expansion through turbines, gas because it wouldn't have to be separated from liquid via rotation) could be used to cause rotation of the power plant. However, in the case where compressed air or propellant is expelled to start rotation, there would be a limited number of times this could be done before having to replace the gas or propellant.

Once constructed and deployed, there is no requirement for continuous fueling to produce power and there is no need for a continuous source of water for cooling. Waste streams produced by fuel burning and water cooling associated with present power production technologies are eliminated. In a more detailed aspect, the satellite may be in a non-geosynchronous orbit so as to be continuously facing the sun and thereby continuously operational.

In other aspects, the electrical energy is then converted into a transmittable form such as microwave energy. The microwave energy is directionally transmitted to a receiving station which may also be in orbit or on the surface of the planet. Transmission of electrical energy to the earth's surface in one embodiment uses a series of geosynchronous relay satellites positioned optimally for transmission to receiving stations on the surface. In yet further detailed aspects, receiving stations on earth would then rectify the microwave energy and convert it back into electrical current for use in the global power grid. In another more detailed aspect, the power generated at the satellite may be converted to specific transmittable wavelengths and/or otherwise controlled for the purpose of interacting with material or materials located in the medium through which the power it transmitted. For example, when transmitting through the medium of the atmosphere, the power can be controlled to interact with and decompose greenhouse gases. Just as microwave is the ideal wavelength to separate the H—O bond in the water molecule, an alternate wavelength ideal for separating the C═O bond in carbon dioxide, and the C—H bond in methane can be used.

The invention may be embodied in other forms without departure from the spirit, scope, and essential characteristics thereof. The embodiments described therefore are to be considered in all respects as illustrative and not restrictive. Although the present invention has been described in terms of certain preferred embodiments and applications, other embodiments and applications that are apparent to those of ordinary skill in the art are also within the scope of the invention.

As examples, the invention has been shown and described for providing electrical energy to a surface-based power grid. However, the electrical energy generated by the orbiting power plant in accordance with the invention may instead be used to power equipment located on the same satellite for other uses. Further, the electrical energy generated by the orbiting power plant may be transmitted to an associated satellite or satellites for use in powering equipment on those associated satellites. The capability of the orbiting power plant in accordance with the invention to provide large amounts of uninterrupted electrical energy makes it suited for supporting other orbiting or space-based equipment requiring such large amounts of electrical power for operation.

Further, the energy produced by the orbiting power plant in accordance with the invention has been described as being transformed to microwave energy for transmission to earth or to other satellites for relay to the power grid on earth. The invention is not meant to be limited to conversion of the generated electrical energy to microwave form. As other technologies are developed, it is possible that these emerging technologies may enable conversion of the electrical energy to other forms, such as light energy, for transmission to earth. Accordingly, the scope of the invention is intended to be defined only by reference to the appended claims.

I claim:

1. An orbiting power plant for generating electrical energy in a microgravity environment from solar radiation, the orbiting power plant comprising:
a hull;
an electrical generator disposed in the hull and having an input and an output, the generator comprising a moving electrical device at the input, the generator configured to produce electrical energy at the output in response to the application of energy to the moving electrical device at its input, wherein the moving electrical device has a first movement direction;
a radiation collection system configured to receive solar radiation energy and direct the solar radiation energy to a predetermined position on the hull;
a working-fluid engine comprising a first stage disposed at the predetermined position on the hull at which a lower-energy-state working fluid absorbs the directed solar radiation energy to result in a higher energy state of the working fluid, a second stage at which the higher energy state working fluid is applied to the moving electrical device at the input of the generator at which at least some of the energy of the working fluid is transferred to the moving electrical device whereby electrical energy is generated, and a third stage at which the higher-energy-state working fluid releases energy to result in a lower energy state; and
a pseudo gravity generation system to which the higher-energy-state working fluid is applied to transfer energy to said pseudo gravity system, the pseudo gravity generation system configured to generate a pseudo gravity environment in the orbiting power plant in response to the energy from the working fluid thereby producing a buoyant force in the hull to enable operation of the working-fluid engine and providing force that opposes tendency of the hull to move with the moving electrical device of the generator.

2. The orbiting power plant according to claim 1, wherein the moving electrical device comprises a rotor with attached generator turbine to which energy of the working fluid is applied to cause rotation of the rotor in the first movement direction to generate electrical energy.

3. The orbiting power plant according to claim 2, wherein the pseudo gravity system comprises a hull turbine to which the working fluid is applied to impart rotational force to the hull opposite to the rotation direction of the rotor to oppose tendency of the hull to move with the rotor.

4. The orbiting power plant according to claim 3:
wherein the generator turbine and the hull turbine are co-located with the generator turbine disposed within the hull turbine, with both turbines having a plurality of turbine blades with the blades of the generator turbine having a different orientation than the blades of the hull turbine so that the hull turbine and the generator turbine rotate in different directions when exposed to the working fluid; and
further comprising a manifold feeding the working fluid to both the generator and hull turbines.

5. The orbiting power plant according to claim 3, wherein:
the pseudo gravity system comprises a turbine to which the working fluid is applied to cause the hull to rotate and create centrifugal force; and
the working-fluid engine comprising a liquid separator at the predetermined position of the solar radiation configured to permit the working fluid in the higher-energy state to pass to the turbines but to restrict the working fluid in a liquid state from passing.

6. The orbiting power plant according to claim 1, wherein the pseudo gravity system comprises a hull turbine to which the working fluid is applied to impart force to the hull opposite to the first movement direction of the rotor to oppose tendency of the hull to move with the rotor.

7. The orbiting power plant according to claim 1, wherein:
the working fluid engine comprises a cooling system configured to cool the working fluid to the lower-energy state after it has applied energy to the generator and hull;
the hull comprises a shield located between the source of solar radiation and the cooling system to shield the cooling system from direct solar radiation whereby the temperature of the environment of the cooling system is less than the temperature of the environment of the solar radiation collection system.

8. The orbiting power plant according to claim 7, further comprising an attitude control system configured to automatically align the orbiting power plant with a solar source from which solar radiation is received whereby the shield is placed in position to shield the cooling system from the solar radiation being received.

9. The orbiting power plant according to claim 8, wherein the attitude control system comprises a plurality of masses and a mass position control system with which the positions of the masses are adjustable whereby the attitude of the orbiting power plant may be adjusted.

10. The orbiting power plant according to claim 1, wherein the radiation collection system comprises a plurality of reflectors configured and located to reflect solar radiation to the predetermined position on the hull at which the first stage of the working fluid engine is located.

11. The orbiting power plant according to claim 1, further comprising a wireless transformer configured to wirelessly transmit the energy produced by the electrical generator to a remote location.

12. The orbiting power plant according to claim 11, wherein the transformer is further configured to selectively control at least one characteristic of the electrical energy transmitted to the remote location such that the transmitted energy will interact with a material disposed in a medium located between the transformer and the remote location to alter a characteristic of the material.

13. The orbiting power plant according to claim 1, further comprising a refrigerant cooling system disposed about the electrical generator to provide cooling to the generator.

14. The orbiting power plant according to claim 13, wherein the refrigerant cooling system is also disposed to provide cooling to the working fluid.

15. An orbiting power plant for generating electrical energy in a microgravity environment from solar radiation, the orbiting power plant comprising:
a hull;
an electrical generator disposed in the hull and having an input and an output, the generator comprising a rotor at the input, the generator configured to produce electrical energy at the output in response to the application of energy to the rotor at its input, wherein the rotor has a first movement direction;
a radiation collection system comprising a plurality of reflectors configured and located to reflect solar radiation to the predetermined position on the hull;
a working-fluid engine comprising a first stage disposed at the predetermined position on the hull at which a lower-energy-state working fluid absorbs the directed solar radiation energy to result in a higher energy state of the working fluid, a second stage at which the higher energy state working fluid is applied to the rotor at the input of the generator at which at least some of the energy of the working fluid is transferred to the rotor whereby electrical energy is generated, and a third stage comprising a cooling system to which the higher-energy-state working fluid is applied, the cooling system being configured to remove energy from the working fluid to result in a lower energy state;
a pseudo gravity generation system to which the higher-energy-state working fluid is applied to transfer energy to said pseudo gravity system, the pseudo gravity generation system configured to generate a pseudo gravity environment in the orbiting power plant in response to the energy from the working fluid thereby producing a buoyant force in the hull to enable operation of the working-fluid engine and providing force that opposes tendency of the hull to move with the moving electrical device of the generator; and
a refrigerant system disposed about the generator to remove heat from the generator and disposed about the cooling system to remove heat from the cooling system and working fluid.

16. The orbiting power plant according to claim 15, wherein:
the pseudo gravity system comprises a hull turbine to which the working fluid is applied to cause the hull to rotate and create centrifugal force thereby creating buoyant force in the hull; and
the working fluid engine comprises a liquid separator configured to permit the more buoyant working fluid in the higher-energy state to pass through the membrane and proceed to the turbines but to restrict the less buoyant working fluid in a liquid state from passing through the membrane.

17. The orbiting power plant according to claim 16 wherein:
the working-fluid engine comprises a boiler within which is disposed the membrane;
the liquid separator comprises a filter disposed between the boiler and solar radiation reflected to the predetermined hull position, the filter configured to permit the passage of thermal energy of the radiation and further configured to block wavelengths of energy in the solar radiation that is harmful to the boiler material.

18. The orbiting power plant according to claim 15, further comprising:
a rotor turbine connected with the rotor, the working fluid being applied to the rotor turbine to rotate the rotor and thereby produce electrical energy at the output of the generator; and
a hull turbine connected with the hull, the working fluid being applied to the hull turbine, the hull turbine configured to rotate in a direction different from the rotor turbine to thereby provide opposing rotational force to the hull to oppose rotation of the hull in the same direction as the rotor.

19. The orbiting power plant according to claim 18, wherein the rotor turbine and the hull turbine are co-located.

20. An orbiting power plant for generating electrical energy in a microgravity environment from solar radiation, the orbiting power plant comprising:
a hull;
an electrical generator disposed in the hull and having an input and an output, the generator comprising a rotor to which is attached a rotor turbine whereby rotation of the rotor turbine causes rotation of the generator rotor to thereby produce electrical energy at the output, the hull turbine and rotor having a first movement direction;
a radiation collection system comprising a plurality of reflectors configured and located to reflect solar radiation to the predetermined position of the hull;
a working-fluid engine comprising a first stage disposed at the predetermined position of the hull at which a lower-energy-state working fluid absorbs the directed solar radiation energy to result in a higher energy state of the working fluid, a second stage at which the higher energy state working fluid is applied to the rotor turbine at the input of the generator at which at least some of the energy of the working fluid is transferred to the rotor turbine whereby electrical energy is generated, and a third stage located at a cooling system at which the higher-energy-state working fluid releases energy to the cooling system to result in a lower energy state; and
a pseudo gravity generation system comprising a hull turbine connected with the hull to which the higher-energy-state working fluid is applied to transfer energy to the hull turbine, the hull turbine configured to rotate the hull in response to application of the working fluid to create centrifugal force in the hull to thereby create a pseudo gravity environment in the hull and thereby produce a buoyant force in the hull to enable separation of higher-energy working fluid to separate from lower-energy working fluid;
the working engine further comprises a boiler within which is contained a membrane configured to permit the passage of the working fluid that is at the higher energy level and block the working fluid that is at the lower energy level, the boiler disposed in the center of the hull; and
a shield disposed on the hull to block solar radiation from reaching the cooling system.
